(19) United States
(12) Patent Application Publication
(10) Pub. No.: US 2008/0080440 A1
(43) Pub. Date: Apr. 3, 2008

(54) Device interfaces to integrate cooperative diversity and mesh networking

(76) Inventors: Mark D. Yarvis, Portland, OR (US); Sumeet Sandhu, Santa Clara, CA (US); W. Steven Conner, Portland, OR (US)

Correspondence Address: INTEL CORPORATION;c/o INTELLEVATE, LLC, P.O. BOX 52050, MINNEAPOLIS, MN, 55402, US

(21) Appl. No.: 11/541,188

(22) Filed: Sep. 30, 2006

(51) Int. Cl. H04Q 7/24

(52) U.S. Cl. 370/338

(57) ABSTRACT

Methods, protocols and systems for communicating in a multi-hop wireless mesh network may use cooperative diversity transmission techniques in combination with mesh routing. In one example, a cooperation layer may be integrated with MAC and/or PHY layers and generate a plurality of virtual interfaces for use by a mesh routing layer. The plurality of virtual interfaces may include a first interface type defining potential mesh nodes that can be reached without using cooperative diversity transmission techniques, a second interface type defining potential mesh nodes that can be reached by cooperatively transmitting with one neighbor node, and a third interface type defining potential mesh nodes that can be reached by cooperatively transmitting with combinations of two or more neighbor nodes. The mesh routing layer may select which interface to use in determining multi-hop routing based on a range and/or cost metric of a particular virtual interface.

### BACKGROUND OF THE INVENTION.

It is becoming increasingly attractive to use wireless nodes in a wireless network as relaying points to extend range, increase redundancy and/or reduce costs of a wireless network.

A type of network which uses wireless stations (fixed infrastructure and/or mobile stations) to relay signals between a source and destination is colloquially referred to herein as a mesh network. While some attempt to distinguish the term “mesh network” and “mobile multi-hop relay (MMR) network” by virtue that the former may use fixed and/or mobile stations as relaying points and the latter may use only fixed infrastructure relay stations, they are not necessarily so distinguished and may in fact be interchangeably used herein without limiting the scope of the inventive embodiments.

In mesh networks, wireless network nodes may form a “mesh” of potential paths for which a communication may travel to reach its destination. Optimizing communications through a mesh network have become the subject of much focus and there are ongoing efforts to increase the efficiency of transmissions through wireless mesh networks.

### BRIEF DESCRIPTION OF THE DRAWING

Aspects, features and advantages of embodiments of the present invention will become apparent from the following description of the invention in reference to the appended drawing in which like numerals denote like elements and in which:

FIG. 1 is a block diagram illustrating an arrangement of wireless nodes in an example wireless mesh network according to various embodiments of the present invention;

FIG. 2 is a block diagram illustrating an arrangement of wireless nodes which may used cooperative diversity transmission techniques in an example wireless network according to various embodiments of the present invention;

FIG. 3 is a block diagram of an example protocol stack which may be used for multi-hop routing using multiple physical interfaces according to various embodiments;

FIGS. 4-7 are functional block diagrams showing potential ranges for forwarding communications in a multi-hop network with or without cooperative diversity transmissions;

FIG. 8 is a block diagram showing a network stack integrating a multi-hop or mesh network layer with a cooperative diversity enabled MAC/PHY layers using virtual interfaces according to various embodiments;

FIGS. 9-11 are network diagrams showing example operation of multi-hop routing using cooperative diversity according to various aspects of the invention; and

FIG. 12 is a block diagram illustrating an example wireless device according to one or more embodiments of the present invention.

### DETAILED DESCRIPTION OF THE INVENTION

While the following detailed description may describe example embodiments of the present invention in relation to wireless local area networks (WLANs) and related devices, the inventive embodiments are not limited thereto and can be applied to other types of wireless networks and devices where similar advantages may be obtained. Such networks for which inventive embodiments may be applicable specifically include, wireless personal area networks (WPANs), wireless metropolitan area networks (WMANs) and/or wireless wide area networks (WWANs). Additionally, embodiments of the present invention may be specifically related to devices using a combination of WLAN, WMAN and/or WWAN over-the-air (OTA) protocols.

The following inventive embodiments may be used in a variety of applications including transmitters and receivers of a radio system. Radio systems specifically included within the scope of the present invention include, but are not limited to, network interface cards (NICs), network adaptors, mobile stations, base stations, access points (APs), hybrid coordinators (HCs), gateways, bridges, hubs and routers. Further, the radio systems within the scope of the invention may include cellular radiotelephone systems, satellite systems, personal communication systems (PCS), two-way radio systems and two-way pagers as well as computing devices including radio systems such as personal computers (PCs) and related peripherals, personal digital assistants (PDAs), personal computing accessories and all existing and future arising systems which may be related in nature and to which the principles of the inventive embodiments could be suitably applied.

Wireless mesh systems are the focus of several current standardization efforts. For example, the Institute of Electrical and Electronics Engineers (IEEE) 802.11s Mesh Task Group (TG) is actively working on standard solutions for WLAN mesh networking. Additionally, the IEEE 802.16j Mobile Multi-hop Relay (MMR) task group is also evaluating solutions for standardization in furtherance of the IEEE 802.16j project approval request (PAR) (Approved: Mar. 30, 2006) for wireless broadband access (WBA) networks. Embodiments of the present invention may be compatible with one or more of the physical layer (PHY) and/or medium access control (MAC) layer protocols defined by these and/or other IEEE 802.x wireless standards although the inventive embodiments are not limited in this respect. Additionally or alternatively, embodiments of the present invention may use protocols compatible with other wireless standards and/or cellular protocols such as general packet radio service (GPRS), various generations of code division multiple access (CDMA) including wideband CDMA (WCDMA), 3^{rd} Generation Partnership Project (3GPP) and similar WWAN protocols.

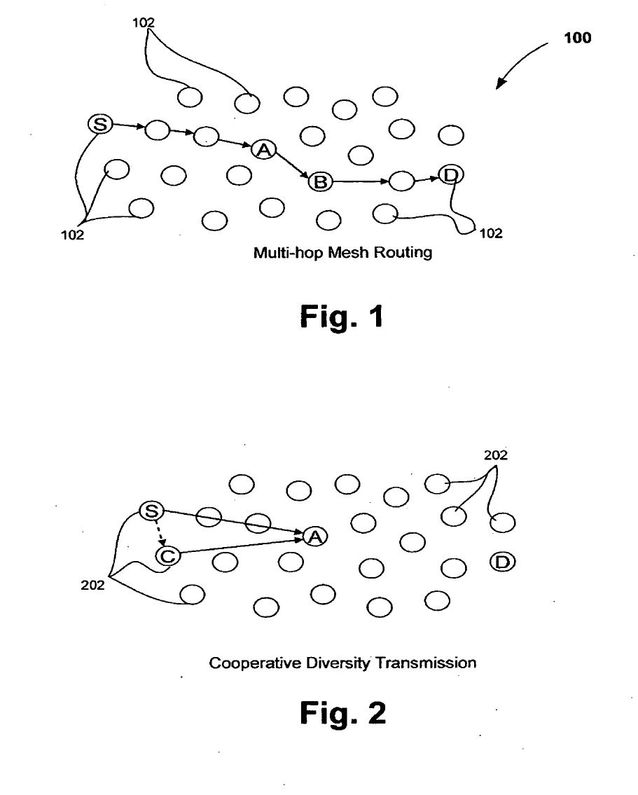

Multi-hop (or mesh) routing and cooperative diversity (e.g., distributed multiple-input multiple-output (MIMO)) are two technique proposed for use in various wireless networks (e.g., data exchange networks and sensor networks). These techniques allow communication between wireless nodes that are beyond normal radio range of each other by leveraging transmission capabilities of other nearby or neighboring nodes. Turning to FIG. 1, a mesh network 100 may include a plurality of nodes (generally designated 102). For multi-hop routing, a packet can be forwarded sequentially from one node to the next until it is received at the ultimate destination (e.g., along a path from node S to Node D).

Turning to FIG. 2, a similar network 200 may include a plurality of nodes 202 that may use cooperative diversity transmission techniques. With cooperative diversity, two nodes, e.g., node S and node C, can transmit simultaneously such that their combined signal strength allows a distant node, e.g., node A, to receive the transmission.

These two techniques are not mutually exclusive. Depending on signal propagation and node topology, one or the other may be more effective. For example, one choice may be more energy efficient than the other. In other cases, only one of the techniques may be feasible. For example, a gap in network topology that is wider than the radio range may be crossed via cooperative diversity but not via multi-hop routing.

Accordingly, in various of the inventive embodiments, cooperative diversity and multi-hop routing can be used in combination to achieve efficient and/or extended communication across a wireless network (e.g., 100 or 200). However, integration of these two techniques may be challenging as each technique may affect the other. For example, a certain multi-hop path may affect which nodes would be useful in cooperative diversity transmission. Conversely, cooperative diversity transmission may change the set of available links from which a multi-hop path can be selected.

In a previous patent application, U.S. application Ser. No. 11/206,494 entitled “Methods and Apparatus for Providing an Integrated Multi-hop Routing and Cooperative Diversity System” filed on Aug. 17, 2005 by the present inventors, an integration of multi-hop routing and cooperative diversity was proposed which used explicit coordination between the routing and cooperation layers.

However, various embodiments of the present invention do not require such coordination thereby allowing any routing protocol that supports multiple interfaces to be integrated with any cooperation protocol that exposes multiple interfaces. To this end, various embodiments herein propose the use of virtual interfaces each representing a different pattern of potential cooperation, to integrate a multi-hop (mesh) routing layer that supports multiple communication interfaces with a cooperation-enabled MAC/PHY layer which require minimal integration between the two layers.

Mesh Routing Over Multiple Interfaces

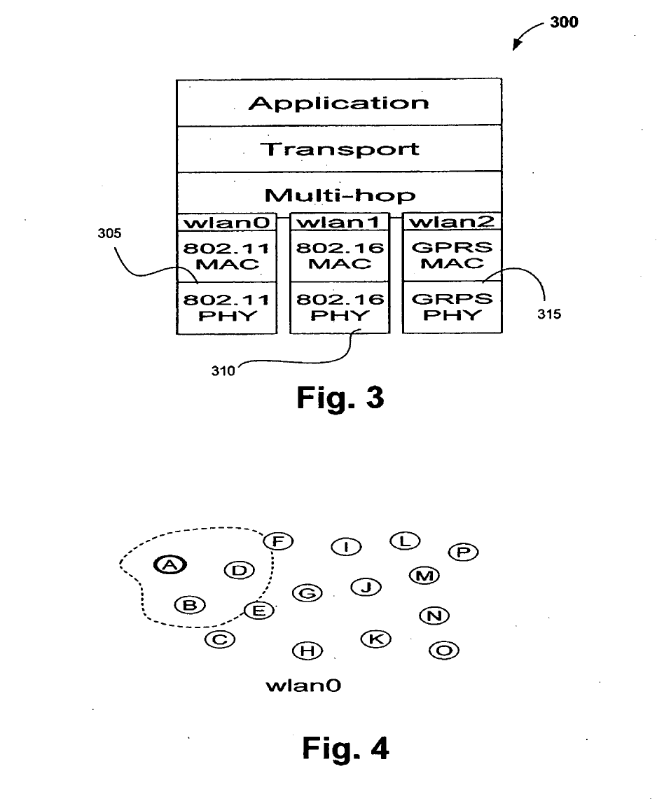

Embodiments of the present invention may utilize a multi-hop routing protocol that supports routing across multiple MAC/PHY interfaces. By way of one non-limiting example, a wireless node might include a WLAN radio (e.g., an 802.11 radio), a WBA or WMAN radio (e.g., an 802.16 radio), and a WWAN radio (e.g. a GPRS radio). In this example, a protocol stack 300 similar to that of FIG. 3 might be used by the wireless node. Incoming packets from one MAC/PHY interface (e.g., WLAN interface 305) can be routed across any outgoing MAC/PHY interface 310, 315 (including the ingress interface 305). Protocols have been proposed for mesh networking that support routing across multiple physical interfaces. Examples of such previous proposals may be found in U.S. patent application Ser. Nos. 11/030,016, 11/030,592, and 11/030,593, as well as in “Routing in Multi-Radio, Multi-Hop Wireless Mesh Networks,” Draves, J. Padhye, B. Zill, MobiCom '04, Philadelphia, Pa., Sep. 26-Oct. 1, 2004.

Creating Multiple Interfaces With Cooperation

In various embodiments, the cooperation diversity layer or “cooperation layer” is a capability that may be integrated with the MAC and/or PHY layer of a given physical transceiver device such as a radio.

Typically a given transceiver would have a single interface provided by the software above the MAC/PHY layers. However, according to embodiments of the present invention, multiple virtual interfaces may be presented for potential use. In one example implementation, three basic types of virtual interfaces may be created by the cooperation layer: (i) a first virtual interface type in which no cooperative diversity is used; (ii) a second virtual interface type representing potential diversity transmission interfaces possible through cooperative diversity transmissions with each neighboring node individually; and (iii) a third virtual interface type representing potential diversity transmission interfaces possible with cooperative diversity transmissions utilizing a combination of neighboring nodes.

By way of example referring to FIG. 4, for the first interface type, a cooperation layer in a wireless node (e.g., Node A) may create a single MAC/PHY interface which allows packets to be sent from Node A without any cooperative transmission with other nodes. For example, this virtual interface might be referenced as “wlan0.” The effective range for a next hop, e.g., the nodes with which communications using the first interface type “wlan0” is graphically illustrated in FIG. 4 as including either Node B or Node D.

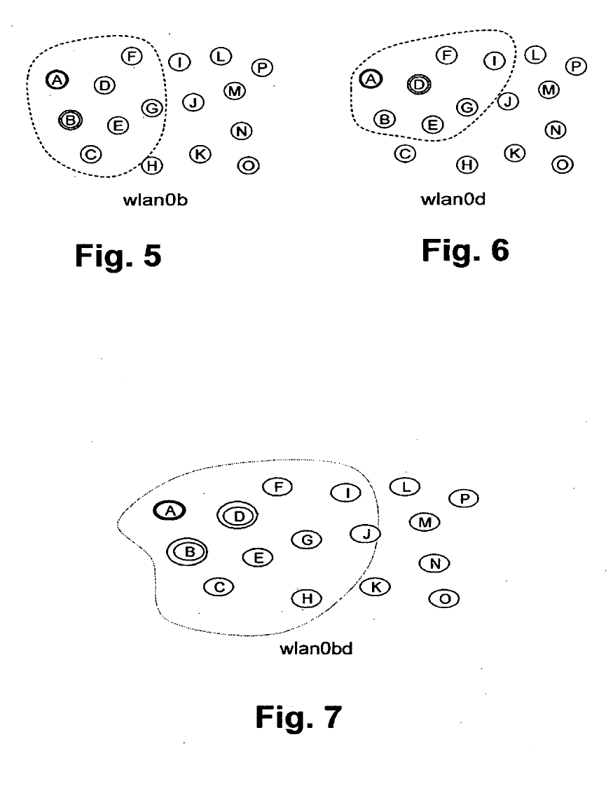

Turning to FIGS. 5 and 6, for the second interface type, virtual interfaces “wlan0b” and “wlan0d” may be respectively created based on Node A's cooperation with neighbor Node B and separately, Node A's cooperation with neighbor Node D. The effective range for a next hop using cooperation with Node B (e.g., using the “wlan0b” interface) is shown in FIG. 5 to include Nodes C, D, E, F and G. The effective range for a next hop using the “wlan0d” interface is shown in FIG. 6 to include Nodes B, E, F, G and I.

Lastly, he third type of interface created by the cooperation layer may include interfaces created representing potential collaboration with combinations of neighboring nodes. Referring back to FIG. 4 for simplicity, only one such combination is possible which includes Node A's cooperation with both Node B and Node D. Thus, as shown in FIG. 7, the virtual interface “wlan0bd” would be created.

Because each of the above interfaces implies cooperation with a different set of neighbors, each virtual interface created allows communication to a different set of network nodes. For example, in FIG. 4, Node A can reach Nodes B and D via via interface wlan0. In FIG. 5, via cooperation with Node B, node A can reach Nodes C, D, E, F, and G through interface wlan0b. In FIG. 6, via cooperation with Node D, node A can reach Nodes B, E, F, G, and I through interface wlan0d. In FIG. 7, via cooperation with both Node B and Node D, node A can effectively reach Nodes C, E, F, G, H, I and J through interface wlan0bd.

It should be recognized that the “wlan” interfaces described above may simply be interfaces created for a particular WLAN MAC/PHY layer and that similar virtual interfaces might alternatively or additionally be created for other types of physical interfaces present on the wireless node such as WWPAN, WMAN and/or WWAN wireless interfaces.

Integrating the Cooperation Layer with the Multi-hop Network Layer

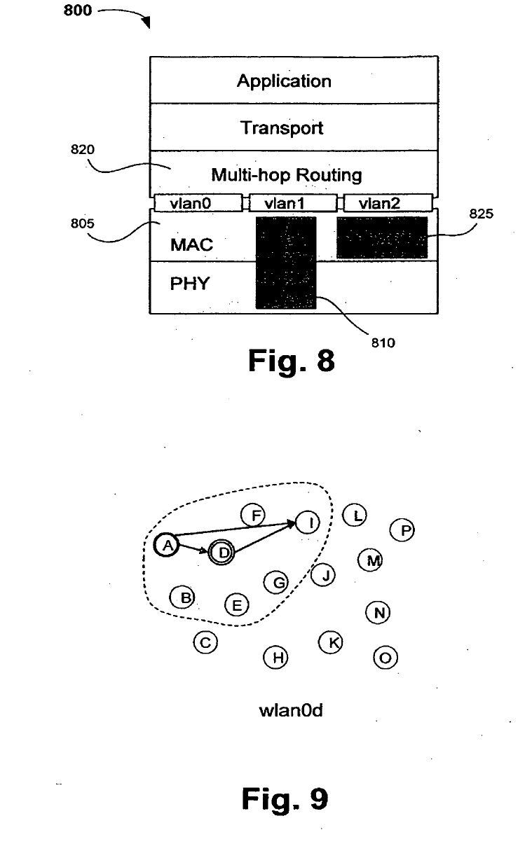

An example protocol stack 800 for implementing interface-based integration of cooperation and multi-hop routing is shown in FIG. 8. In this example, the three types of virtual interfaces VLAN 1, VLAN 2 and VLAN 3 are presented on top of the MAC layer 805 representing the different forms of cooperation, as described above.

According to one or more embodiments, a cooperation component 810 is integrated with the PHY and/or MAC layers. Cooperation component 810 takes a packet received from the network layer 820 (via one of virtual interfaces VLAN0, VLAN1 or VLAN2) and transmits the packet in cooperation with the constellation of nodes represented by that virtual interface. Received packets may be delivered to an interface VLAN0, VLAN1 or VLAN2 depending on the set of nodes that cooperated to transmit the packet.

In one embodiment, MAC layer 805 may include a neighbor node list component 825 that tracks the set of nodes within communication range of the local node (without cooperation); i.e., neighbor nodes. This node list 825 may be used to determine the set of nodes the local node can cooperate with, and hence the set of available interfaces.

The multi-hop networking or routing layer 820 may be therefore be a conventional mesh routing layer since it doesn't require any explicit signaling with cooperation layer 810. In certain implementations, routing layer 820 may send and receive topology discovery messages (e.g., route updates or route requests) via the various communication interfaces. Depending on the implementation, routing layer 820 may choose to perform neighbor node discovery (typically via single hop beacons) on each of the underlying virtual interfaces to determine the set (and perhaps quality) of the available network layer links. Alternately, the cooperation layer 810 can provide an interface for assessing link quality to each effective neighbor.

### EXAMPLE OPERATION

Take, for example, the network of FIGS. 4-7 described earlier. Referring to FIGS. 9-11, Node A wants to find a route to Node P using a combination of multi-hop communication and distributed cooperation.

Each node A-P may create a neighbor list that determines which interfaces will be available to the multi-hop layer (e.g., layer 820; FIG. 8). The following table represents an example neighbor list for node A:

TABLE 1
A-NEIGHBORS
B
D

FIG. 9 shows the first communication hop from node A. The routing table shown below in Table 2 includes entries for a variety of different interfaces that might be used by node A to reach node P:

TABLE 2

| | NEXT | | |
|---|---|---|---|
| DESTINATION | HOP | INTERFACE | METRIC |
| P | I | wlan0d | 2 |
| P | D | wlan0 | 4 |
| P | B | wlan0b | 3 |

Note that in reality, routing table 2 may or may not include multiple entries for the same destination (they are included for clarity of explanation). In this case, cooperation with Node D (enabled using interface wlan0d) allows node A to reach node in one hop, resulting in a cost of (2) to reach node P. Cooperation with Node B (wlan0b) and no cooperation (wlan0) both result in a greater routing metric. While hop count is used as a metric in this example, other metrics (such as ETX (expected transmission count), ETT (expected transmission time), weighted cumulative ETT (WCETT), etc.) can be used to better select between different routes and different interfaces.

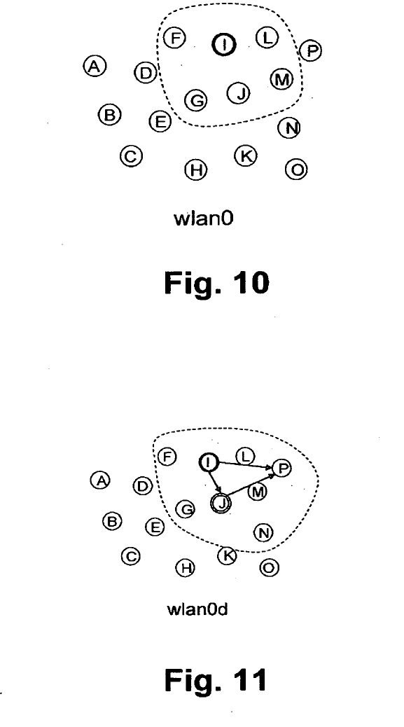

A packet destined for Node P (in this case originating from node A) would be forwarded to Node I, and in turn be forwarded by the multi-hop layer at Node I to the destination hop toward Node P. FIG. 10 shows the single hop neighborhood of Node I (without cooperation) and Node I's neighbor table may be as follows in Table 3:

TABLE 3
I-NEIGHBORS
F
G
J
L
M

Node I's routing table, complete with routes through several interfaces made available through cooperation or no cooperation may include information as shown in Table 4:

TABLE 4

| | NEXT | | |
|---|---|---|---|
| DESTINATION | HOP | INTERFACE | METRIC |
| P | P | wlan0j | 1 |
| P | L | wlan0 | 2 |
| P | P | wlan0m | 1 |
| P | P | Wlan0l | 1 |

Many of these interfaces allow node P to be reached directly, allowing the packet to be delivered without further hops. FIG. 11 shows that using interface wlan0j (via cooperation with Node J) allows the packet to be delivered with the lowest cost metric although other interfaces may have similar metrics and could be chosen as instead.

The combination of multi-hop routing and cooperative diversity can provide obvious advantages and, other than in previous U.S. application Ser. No. 11/206,494 referenced earlier has not been suggested. This application differs in several respects from the earlier application. Most notably, no explicit signaling is required between the multi-hop layer and the cooperation layer. Thus any multi-hop implementation that supports multiple communication interfaces can be used, without modification. Consequently, most of the work involved in finding and leveraging cooperators is pushed into the cooperation layer which is integrated into the MAC and/or PHY layers. The routing layer simply takes advantage of links made available by the cooperation layer.

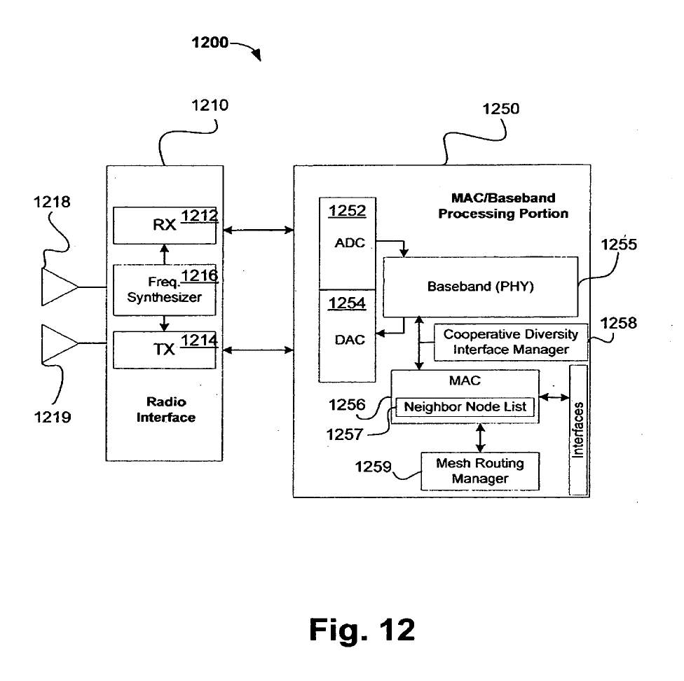

Referring to FIG. 12, an apparatus 1200 for use in a wireless mesh network according to the various embodiments may include a processing circuit 1250 including logic (e.g., circuitry, processor(s), software, or combination thereof) to control wireless mesh routing and cooperative diversity virtual interface creation as described in one or more of the embodiments above. In certain embodiments, apparatus 1200 may generally include a radio frequency (RF) interface 1210 and a baseband and MAC processor portion 1250.

In one example embodiment, RF interface 1210 may be any component or combination of components adapted to send and receive modulated signals (e.g., using orthogonal frequency division multiple access (OFDMA)) although the inventive embodiments are not limited in this manner. RF interface 1210 may include, for example, a receiver 1212, a transmitter 1214 and a frequency synthesizer 1216. Interface 1210 may also include bias controls, a crystal oscillator and/or one or more antennas 1218, 1219 if desired. Furthermore, RF interface 1210 may alternatively or additionally use external voltage-controlled oscillators (VCOs), surface acoustic wave filters, intermediate frequency (IF) filters and/or radio frequency (RF) filters as desired. Various RF interface designs and their operation are known in the art and the description for configuration thereof is therefore omitted.

In some embodiments interface 1210 may be configured to provide OTA link access which is compatible with one or more of the IEEE standards or other standards for WPANs, WLANs, WMANs or WWANs, although the embodiments are not limited in this respect.

Processing portion 1250 may communicate/cooperate with RF interface 1210 to process receive/transmit signals and may include, by way of example only, an analog-to-digital converter 1252 for digitizing received signals, a digital-to-analog converter 1254 for up converting signals for carrier wave transmission, and a baseband processor 1255 for physical (PHY) link layer processing of respective receive/transmit signals. Processing portion 1250 may also include or be comprised of a processing circuit 1256 for media access control (MAC)/data link layer processing and include a neighbor node list 1257 as described previously.

In certain embodiments of the present invention, a cooperative diversity interface manager 1258 may be included in processing portion 1250 and which may function to create virtual interfaces for use by a mesh routing manager 1259 as described in any of the embodiments above. In certain embodiments, mesh routing manager 1259 include functionality to determine cost metrics and/or identify next hop nodes to build and/or store mesh routing tables using virtual interface information provided by the cooperative diversity manager 1258 similar to that described previously.

Alternatively or in addition, PHY circuit 1255 or MAC processor 1256 may share processing for certain of these functions or perform these processes independently. MAC and PHY processing may also be integrated into a single circuit if desired.

Apparatus 1200 may be, for example, a wireless base station, a client station, an access point (AP), a hybrid coordinator (HC), a wireless router and/or a network adaptor for electronic devices. Apparatus 1200 could also be a mobile subscriber station or network interface card (NIC) for an electronic computing device. Accordingly, the previously described functions and/or specific configurations of apparatus 1200 could be included or omitted as suitably desired.

Embodiments of apparatus 1200 may be implemented using single input single output (SISO) architectures However, as shown in FIG. 12, certain implementations may use multiple input multiple output (MIMO), multiple input single output (MISO) or single input multiple output (SIMO) architectures having multiple antennas (e.g., 1218, 1219) for transmission and/or reception. Further, embodiments of the invention may utilize multi-carrier code division multiplexing (MC-CDMA) multi-carrier direct sequence code division multiplexing (MC-DS-CDMA) for OTA link access or any other existing or future arising modulation or multiplexing scheme compatible with the features of the inventive embodiments.

The components and features of apparatus 1200 may be implemented using any combination of discrete circuitry, application specific integrated circuits (ASICs), logic gates and/or single chip architectures. Further, the features of apparatus 1200 may be implemented using microcontrollers, programmable logic arrays and/or microprocessors or any combination of the foregoing where suitably appropriate (collectively or individually referred to as “logic”).

It should be appreciated that apparatus 1200 represents only one functionally descriptive example of many potential implementations. Accordingly, division omission or inclusion of block functions depicted in the accompanying figures does not infer that the hardware components, circuits, software and/or elements for implementing these functions would be necessarily be divided, omitted, or included in embodiments of the present invention.

Unless contrary to physical possibility, the inventors envision (i) the methods described herein may be performed in any sequence and/or in any combination; and (ii) the components of respective embodiments may be combined in any manner.

Although there have been described example embodiments of this novel invention, many variations and modifications are possible without departing from the scope of the invention. Accordingly the inventive embodiments are not limited by the specific disclosure above, but rather should be limited only by the scope of the appended claims and their legal equivalents.

1. A method for communicating in a wireless mesh network, the method comprising:
determining a plurality of virtual interfaces for use by a mesh routing layer, the plurality of virtual interfaces comprising at least a first interface type defining potential mesh nodes that can be reached without using cooperative diversity transmission techniques and a second interface type defining potential mesh nodes that can be reached using cooperative diversity transmission techniques.

2. The method of claim 1 wherein the second interface type comprises one or more virtual interfaces defining potential mesh nodes that can be reached using cooperative diversity transmission techniques with only a single one of each neighboring node.

3. The method of claim 2 further comprising a third interface type that comprises one or more virtual interfaces defining potential mesh nodes that can be reach using cooperative diversity transmission techniques based on one or more combinations of cooperative transmissions with at least two neighboring nodes.

4. The method of claim 1 wherein determining the plurality of virtual interfaces is integrated with medium access control (MAC) layer and physical (PHY) layer functions.

5. The method of claim 1 wherein the wireless mesh network utilizes protocols compatible with one or more of the Institute of Electrical and Electronic Engineers (IEEE) 802.11 or 802.16 protocols.

6. The method of claim 1 further comprising selecting a next hop node based on one of the plurality of virtual interfaces having at least one of a longest range or a lowest cost metric.

7. The method of claim 1 wherein the plurality of virtual interfaces are determined for each type of physical interface available to a wireless node.

8. A wireless device comprising:
a processing circuit including a cooperative diversity manager to generate a plurality of virtual interfaces defining wireless nodes that may be reached using cooperative diversity transmissions with one or more neighboring nodes and a wireless mesh routing manager to select a wireless mesh route based on one of the plurality of virtual interfaces.

9. The wireless device of claim 8 wherein the operative diversity manager is integrated with medium access control (MAC) and physical (PHY) layer functions of the wireless device.

10. The wireless device of claim 8 wherein the plurality of virtual interfaces comprise one or more interfaces which result from cooperative transmission with a single neighboring node and one or more interfaces which result from cooperative transmission with two or more neighboring nodes.

11. The wireless device of claim 8 further comprising at least one radio frequency (RF) interface in communication with the processing circuit.

12. The wireless device of claim 8 wherein the wireless device comprises a wireless mesh node adapted to use protocols compatible with one or more Institute of Electrical and Electronic Engineers (IEEE) 802.11 or 802.16 standards.

13. The wireless device of claim 8 wherein the wireless device is configured to transmit communications over a plurality of different physical interfaces.

14. The wireless device of claim 11 wherein the RF interface includes at least two antennas and being adapted for multiple-input multiple-output (MIMO) communications.

15. An article of manufacture comprising a tangible medium storing readable code that, when executed by a processing device, causes the processing device to:
determine a plurality of virtual interfaces comprising at least a first type of interface to transmit in a wireless mesh network without using cooperative diversity techniques and a second type of interface to cooperatively transmit with one or more neighboring nodes in the wireless mesh network.

16. The article of claim 15 further comprising machine readable code that, when executed by a processing device, causes the processing device to:
select one of the plurality of virtual interfaces to send communications along a multi-hop path in the wireless mesh network.

17. The article of claim 15 wherein the second type of interface comprises one or more virtual interfaces to cooperatively transmit with individual neighboring nodes and one or more virtual interfaces to cooperatively transmit with two or neighboring nodes.

18. A wireless system comprising:
a processing circuit including cooperative diversity logic to generate a plurality of virtual interfaces defining wireless nodes that may be reached using cooperative diversity transmissions with one or more neighboring nodes and a wireless mesh routing logic to select a wireless mesh route based on one of the plurality of virtual interfaces;
a radio frequency (RF) interface communicatively coupled to the processing circuit; and
at least two antennas coupled to the RF interface for at least one of multiple-input or multiple-output (MIMO) communication.

19. The system of claim 18 wherein the cooperative diversity logic is operative to generate a first type of virtual interface in which no cooperative diversity is used, a second type of virtual interface in which virtual interfaces are determined for cooperative transmission with each neighbor node individual, and a third type of virtual interface in which virtual interfaces are determined form cooperative transmission with combinations of neighbor nodes.

20. The system of claim 18 further comprising a medium access control (MAC) circuit and a baseband processing circuit and wherein cooperative diversity logic is integrated with functions of the MAC and baseband processing circuits.

21. The system of claim 20 wherein the MAC, baseband processing circuit and RF interface are adapted for multiple types of physical interfaces including at least a wireless local area network (WLAN) physical interface, a wireless broadband access (WBA) physical interface and a general packet radio service (GPRS) physical interface.
